(19) United States
(12) Patent Application Publication
(10) Pub. No.: US 2025/0236768 A1
(43) Pub. Date: Jul. 24, 2025

(54) ADHESIVE COMPOSITION CONTAINING THERMOPLASTIC POLYMER AND SOLID OXIDE OR SALT PARTICLES EMBEDDED THEREIN

(71) Applicant: UT-Battelle, LLC, Oak Ridge, TN (US)

(72) Inventors: Tomonori Saito, Knoxville, TN (US); Md Anisur Rahman, Knoxville, TN (US); Vera Bocharova, Knoxville, TN (US); Lingyao Meng, Everett, WA (US); Robert L. Sacci, Cleveland, TN (US)

(21) Appl. No.: 19/027,448

(22) Filed: Jan. 17, 2025

Related U.S. Application Data
(60) Provisional application No. 63/622,092, filed on Jan. 18, 2024.

(51) Int. Cl. C09J 7/35; C09J 5/06; C09J 11/04

(52) U.S. Cl. CPC C09J 7/35; C09J 5/06; C09J 11/04; C09J 2301/304; C09J 2301/408; C09J 2400/166; C09J 2471/00

(57) ABSTRACT

An adhesive composition comprising: (i) a thermoplastic polymer; and (ii) solid particles having an oxide or salt composition embedded within the thermoplastic polymer, wherein the salt composition contains a cationic element associated with one or more anions that are not halide atoms. In particular embodiments, the component (i) is selected from polyalkylene oxides (PAOs), poly(meth)acrylates, polyurethanes, polyesters, and thermoplastic epoxy resins, and component (ii) is selected from Al(OH)₃, Si(OH)₄, B(OH)₃, Fe(OH)₃, Fe(OH)₂, FeO(OH), MgCO₃, CaCO₃, SrCO₃, BaCO₃, ZnCO₃, Li₂CO₃, Na₂CO₃, K₂CO₃, Rb₂CO₃, Cs₂CO₃, Al₂(SO₄)₃, Fe₂(SO₄)₃, La₂(CO₃)₃, MgSO₄, CaSO₄, SrSO₄, BaSO₄, ZnSO₄, Li₂SO₄, Na₂SO₄, K₂SO₄, Rb₂SO₄, Cs₂SO₄, Al₂O₃, B₂O₃, SiO₂, Fe₂O₃, Fe₃O₄, FeO, FeO(OH), MgO, CaO, SrO, BaO, ZnO, Li₂O, Na₂O, K₂O, Rb₂O, and Cs₂O, or a combination thereof. Also described herein is a method of bonding first and second surfaces together by placing the above-described adhesive composition between the first and second surfaces and hot pressing the surfaces.

### CROSS-REFERENCE TO RELATED APPLICATIONS

The present application claims benefit of U.S. Provisional Application No. 63/622,092, filed Jan. 18, 2024, all of the contents of which are incorporated herein by reference.

### STATEMENT REGARDING FEDERALLY SPONSORED RESEARCH

This invention was made with government support under Prime Contract No. DE-AC05-000R22725 awarded by the U.S. Department of Energy. The government has certain rights in the invention.

### FIELD OF THE INVENTION

The present invention generally relates to adhesive compositions and methods of bonding objects by use of the adhesives. The invention more particularly relates to thermoplastic polymers, and more particularly, polyalkylene oxide polymers, containing oxide or salt particles embedded therein.

### BACKGROUND

Hot melt adhesives offer a wide range of benefits, making them the perfect choice for a variety of applications where simplified processing, streamlined manufacturing, and end-product protection are paramount. One of the unique features of hot melt adhesives is their ability to form temporary bonding, which is especially beneficial in situations where adjustments or repositioning of components are required during the assembly process. This temporal bonding characteristic is advantageous in intricate assembly tasks, such as those encountered in the electronics or automotive industries, significantly reducing the likelihood of misalignment and waste during the production process. One of the advantages of hot melt adhesives is their simplified processing. Unlike traditional solvent-based adhesives, hot melt adhesives come in solid form and do not require complex mixing or curing processes. They create strong bonds in a matter of seconds. Such versatility and superior bonding capabilities have made them indispensable in numerous industries, from hygiene and furniture manufacturing to packaging and beyond.

However, a significant drawback of most existing hot melt adhesives is their inability to bond a number of different types of surfaces. The conventional adhesive is typically capable of bonding only one type or a limited number of types of surfaces. Another limitation of conventional hot metal adhesives is that their adhesion strengths tend to be low, typically in the range of about 2-4 MPa, which may be sufficient for securing lightweight objects. However, such adhesion strengths are generally inadequate for structural metalwork applications where heavy loads must be supported. None of existing commercial hot melt adhesives can provide a sufficient strength in binding metal surfaces. There would thus be a substantial benefit in a hot melt adhesive that could bind a number of different surfaces with high adhesion strengths.

Moreover, most of the adhesives currently available are permanent adhesives, and are designed for single-use. Permanent adhesives are difficult to remove from the substrate and do not offer recyclability. Thus, ultimately, permanent adhesives end up being incinerated or released into the environment, which can be detrimental to the environment. Thus, there is a further yet unmet need for high strength adhesives that can removed and recycled.

### SUMMARY

The present disclosure provides a novel hot melt adhesive that can bond a diverse range of surfaces, including metals, paper, glass, and wood. In contrast to conventional adhesives that are designed and suited for bonding to specific surface types, the presently described adhesive is a single, all-in-one solution for various materials, which thus simplifies the product selection process. The presently described adhesive also provides exceptional adhesion strengths, generally well above 4, 5, or 6 MPa. The presently described adhesive is also non-corrosive, and may even be anti-corrosive. Moreover, the presently described adhesive can be easily removed, such as by washing with an aqueous solution, and may also be re-used.

More particularly, the presently described adhesive contains at least or solely the following components: (i) a thermoplastic polymer; and (ii) solid particles having an oxide or salt composition embedded within the thermoplastic polymer, wherein the salt composition contains a cationic element associated with one or more anions that are not halide atoms. The thermoplastic polymer may be selected from, for example, polyalkylene oxides (PAOs), (meth)acrylates, polyurethanes, polyesters, and epoxies. Solid particles having a salt composition may contain one or more cationic elements selected from, for example, alkali elements, alkaline earth elements, transition metal elements, main group (metalloid) elements, and lanthanide elements, and one or more anions selected from, for example, hydroxide, carbonate, sulfate, thiosulfate, nitrate, phosphate, borate, cyanate, and thiocyanate. Some examples of salt compositions include Al(OH)₃, Si(OH)₄, B(OH)₃, Fe(OH)₃, Fe(OH)₂, FeO(OH), MgCO₃, CaCO₃, SrCO₃, BaCO₃, ZnCO₃, Li₂CO₃, Na₂CO₃, K₂CO₃, Rb₂CO₃, Cs₂CO₃, Al₂(SO₄)₃, Fe₂(SO₄)₃, MgSO₄, CaSO₄, SrSO₄, BaSO₄, ZnSO₄, Li₂SO₄, Na₂SO₄, K₂SO₄, Rb₂SO₄, and Cs₂SO₄. Solid particles having an oxide composition may be selected from, for example, Al₂O₃, B₂O₃, SiO₂, Fe₂O₃, Fe₃O₄, FeO(OH), MgO, CaO, SrO, BaO, ZnO, Li₂O, Na₂O, K₂O, Rb₂O, and/or Cs₂O. In particular embodiments, the thermoplastic polymer is a polyalkylene oxide, or more particularly, a polymer or copolymer comprising the formula (CH₂CHR—O)ₙH, wherein n is at least or greater than 100, or more particularly, a polyethylene oxide. The solid oxide or salt particles typically have a size within a range of 1 nm to 500 microns. In different embodiments, the particle size may be within a range of 1 nm to 5 microns, or in a range of 1-500 microns, 1-200 microns, 1-100 microns, 1-50 microns, 1-10 microns, 5-500 microns, 5-200 microns, 5-100 microns, or 5-50 microns.

In another aspect, the present disclosure is directed to a method of bonding first and second surfaces together by placing an adhesive composition between the first and second surfaces and hot pressing the surfaces, wherein the adhesive composition can be any of the adhesive compositions described above. The first and second surfaces may independently be selected from, for example, metal, glass, ceramic, paper, or wood surfaces. In some embodiments, the pressing is hot pressing. In some embodiments, in a successive step, the first and second surfaces are thermally debonded and then rebonded. In some embodiments, in a successive step, the adhesive is washed away with a solvent, such as an aqueous solvent, and the removed adhesive may subsequently be removed of the solvent and re-used as an adhesive.

### BRIEF DESCRIPTION OF THE DRAWINGS

FIG. 1 schematically depicts an exemplary process of producing an adhesive composition followed by mixing polymer and salt components followed by hot pressing a film of the adhesive by itself or between two substrates for adhesion measurements.

FIGS. 2a-2d. FIG. 2a is a graph plotting ambient lap shear strengths of composite hot melt adhesive (HMAs) measured on steel as a function of salt concentration in PEO polymer having a Mw=600,000 g/mol. FIG. 2b shows images of hot pressed films of 10 w/w % salt HMA composites, including finely ground composites. FIG. 2c is a graph comparing adhesive properties of PEO_10% Al(OH)₃ and other adhesives, where 1 and 2 are biobased adhesives; 3 and 4 are supramolecular adhesives; 5-8 are mussel-inspired adhesives, commercial glues including HMA, and 9 and 10 are bio-inspired synthetic adhesives. FIG. 2d is a graph plotting lap shear strength of PEO+10 w/w % of salts measured on different substrates.

FIGS. 3a-3b. FIG. 3a is a graph plotting storage modulus and lap shear strength for composites with 10 wt/wt % of salts HMA composites. FIG. 3b shows photos of samples after lab shear testing.

FIG. 4. Graph showing results of stability testing of the selected adhesives bound between metal surfaces. Samples prior to testing were stored at room temperature and 40% relative humidity.

FIGS. 5a-5c. FIGS. 5a and 5b are polarization curves of the HMA composites (containing 10 wt % of Al(OH)₃ and FeCl₃, respectively) hot pressed between two stainless steel plates. FIG. 5c is a graph plotting corrosion potential and the exchange corrosion current obtained from Table 1, plotted as a function of temperature.

FIGS. 6a-6d. FIG. 6a shows photographs of samples containing boric acid before and after lap shear tests on rusted stainless steel (8.1:0.9:0.1 mass ratio of PEO:Al(OH)₃:boric acid).

FIG. 6b shows images of 10 wt % FeCl₃ sample and the boric acid sample (8.1:0.9:0.1 mass ratio of PEO:Al(OH)₃:boric acid) preparation and testing on a rusted cast iron pipe. FIG. 6c shows a pull-off test curve for PEO/Al(OH)₃/Boric HMA adhesive composition. FIG. 6d is a table summarizing the testing results for stainless steel electrodes and cast iron pipe.

### DETAILED DESCRIPTION

In a first aspect, the present disclosure is directed to an adhesive composition containing at least or solely the following components: (i) a thermoplastic polymer; and (ii) solid particles having an oxide or salt composition embedded within the polymer. Typically, particles of component (ii) are dispersed homogeneously (i.e., evenly and regularly) throughout the matrix polymer of component (i). Notably, by virtue of the oxide or salt particles embedded within the polymer, the adhesive composition is provided the ability to form exceptionally strong bonding between surfaces, while the thermoplastic polymer component provides the adhesive with the ability to thermally debond, be easily removed by washing, and be recycled or re-used for rebonding of the same or other surfaces. The adhesive composites are dry-mixed and typically do not contain any solvent. Any of the organic solvents known in the art may be excluded.

The thermoplastic polymer (component (i)) may be a single thermoplastic polymer or a mixture of thermoplastic polymers. The term “polymer,” as used herein, includes homopolymers and copolymers. The copolymer may be, for example, a block, alternating, periodic, random, or branched copolymer and may be a binary, ternary, quaternary, or higher level copolymer. A block copolymer may be a diblock, triblock, tetrablock, or higher block copolymer. The thermoplastic polymer may more particularly be, for example, an addition polymer (e.g., polyalkylene oxide, vinyl-addition, or polyurethane) or condensation polymer (e.g., polyester or polyamide). In some embodiments, the thermoplastic polymer contains one or more of ethylene, propylene, butylene, or styrene units, such as by being a homopolymer of polyethylene (PE), polypropylene (PP), polybutylene (PB), polybutadiene (PBD), or polystyrene (PS), or by being a copolymer containing two or more of PE, PP, PB, PBD, and PS or one or more of the foregoing in combination with any other monomer units (e.g., acrylates or methacrylates) that result in a thermoplastic copolymer. Polyelectrolytes based on any of these polymers are also possible. Biopolymers, such as polysaccharides (e.g., alginates or chitosan), are also possible. In other embodiments, the thermoplastic polymer is selected from polyalkylene oxides (PAOs), poly(meth)acrylates, polyurethanes, polyamides (e.g., nylons), thermoplastic epoxy resins, polyesters (or more particularly PET or a biopolyester, such as PLA, PGA, PCL, PVL, or polytrimethylene terephthalate), polyacrylonitrile (PAN), polycarbonates, polystyrene, polybutadiene, or polybenzimidazole. In one instance, a homopolymer of any of the above polymers is used. In another instance, a copolymer containing any two or more of the above recited polymers is used. In another instance, a physical blend of any of the above recited polymers or copolymers thereof is used. The thermoplastic polymer is typically not chemically crosslinked. However, the polymer may contain some non-covalent reversible crosslink-points initiated by ionic coordination, hydrogen bonding, and hydrophobic interactions.

In particular embodiments, the thermoplastic polymer is or includes a homopolymer or copolymer of a polyalkylene oxide (PAO), also known as a polyether polymer. The PAO can be any of the polyether polymer compositions well known in the art. The PAO is typically of a high enough molecular weight to be a solid at room temperature. The molecular weight of the PAO is typically at least or greater than 500 g/mol (500 Da), 1000 g/mol, 5000 g/mol, 10,000 g/mol, 50,000 g/mol, 100,000 g/mol, 150,000 g/mol, 200,000 g/mol, 250,000 g/mol, 300,000 g/mol, 400,000 g/mol, or 500,000 g/mol (weight-average or number-average). The polyether polymer generally contains a multiplicity (generally at least or more than 10, 20, 30, 40, or 50) of carbon-oxygen-carbon (ether) groups in the backbone of the polymer. In some embodiments, the polyether polymer may or may not contain ether groups in the backbone but contains a multiplicity of ether groups in side chains, such as poly(ethylene glycol)methacrylate (PEGMA), which is also an example of a branched polyether polymer. In some embodiments, the polyether polymer does not contain ether groups in side chains or is not a branched polymer.

PAO homopolymers generally possess the formula HO—(CH₂CHR—O)ₙH, wherein n is typically at least or greater than 10, 20, 50, 100, 200, 500, 1000, or 5000 and R is typically H or a hydrocarbon group, such as methyl or ethyl. The variable n may alternatively be selected to result in any of the molecular weights provided above. The PAO may be or include, for example, polyethylene oxide (PEO) or propylene oxide (PPO). The PAO may alternatively be denoted as a glycol, such as a polyethylene glycol (PEG), polypropylene glycol (PPG), or polybutylene glycol (PBG). In some embodiments, the PAO is a copolymer (e.g., diblock, triblock, alternating, or random) or a mixture of at least two different PAOs, such as PEO mixed with PPO. In the case of copolymers, the PAO contains at least two different types of polyether units, each within the scope of HO—(CH₂CHR—O)ₙ, e.g., a PEO-PPO diblock copolymer of the formula HO—(CH₂CH₂—O)ₙ—(CH₂CH(CH₃)—O)ₘ or a PEO-PPO-PEO or PPO-PEO-PPO triblock copolymer. In some embodiments, the PAO may be or include polybutylene oxide (PBO), i.e., where R in the formula above is ethyl, or alternatively, PBO may correspond to HO—(CH₂CH₂CH₂CH₂—O)ₙH (polytetrahydrofuran). In some embodiments, the PAO is a copolymer or a mixture of PBO and any of PEO and/or PPO. Typically, the PAO contains only one or more PAOs, i.e., without being copolymerized with or mixed with a non-polyether. In other embodiments, the PAO is copolymerized with or mixed with a non-polyether, such as polystyrene (PS), butadiene, or a polyester (e.g., polyethylene terephthalate), such as a PEO-b-PS, PEO-polybutadiene-PEO, or PEO-PET copolymer.

The solid particles (component (ii)) are embedded (i.e., dispersed, typically homogeneously) within the thermoplastic polymer. That is, the thermoplastic polymer functions as a matrix in which the solid particles are dispersed throughout. The solid particles may have any shape, including a spherical, globular (agglomerated or unagglomerated), fibrous, plate-like, amorphous, or polyhedron shape. The solid particles may have a salt or oxide composition, as further discussed below.

The particles can have any suitable size, typically up to or less than 500 microns. In different embodiments, the solid particles have an average size or substantially uniform size of precisely or about, for example, 0.001, 0.005, 0.01, 0.05, 0.1, 0.2, 0.3, 0.4 0.5, 0.6, 0.7, 0.8, 1, 2, 5, 10, 20, 50, 100, 200, 300, 400, or 500 microns, or an average size or substantially uniform size within a range bounded by any two of the foregoing values, e.g., 0.001-500 microns (wherein 0.001 microns=1 nm), 0.001-200 microns, 0.001-100 microns, 0.001-50 microns, 0.001-20 microns, 0.001-10 microns, 0.001-5 microns, 0.01-500 microns, 0.01-200 microns, 0.01-100 microns, 0.01-50 microns, 0.01-20 microns, 0.01-10 microns, 0.01-5 microns, 0.1-500 microns, 0.1-200 microns, 0.1-100 microns, 0.1-50 microns, 0.1-20 microns, 0.1-10 microns, 0.1-5 microns, 1-500 microns, 1-200 microns, 1-100 microns, 1-50 microns, 1-20 microns, 1-10 microns, or 1-5 microns, wherein the term “about” generally indicates no more than ±10%, ±5%, or ±1% from an indicated value. In some embodiments, at least 80%, 85%, 90%, 95%, 98%, or 99% of the particles have a size within any range bounded by any two of the exemplary values provided above. In some embodiments, 100% of the particles have a size within any of the ranges provided above. For particles in which the three dimensions are not the same (e.g., plate or fiber), the particle size may refer to the longest dimension or to an average of two or three dimensions of the particles.

The solid particles are present in the adhesive composition typically in an amount of at least 0.1 wt % by weight of components (i) and (ii). In different embodiments, the solid particles are present in an amount of precisely or about, for example, 0.1, 0.2, 0.5, 1, 2, 3, 4, 5, 10, 15, 20, 25, 30, 35, 40, 45, or 50 wt %, or an amount within a range bounded by any two of the foregoing values, e.g., 0.1-50 wt %, 0.1-40 wt %, 0.1-30 wt %, 0.1-20 wt %, 0.1-10 wt %, 0.1-5 wt %, 1-50 wt %, 1-40 wt %, 1-30 wt %, 1-20 wt %, 1-10 wt %, or 1-5 wt %.

In one set of embodiments, the solid particles have a salt composition. The term “salt composition,” as used herein and for purposes of the invention, refers to solid ionic compositions containing a cationic element associated with one or more anions that are not a Group 16 element (e.g., oxide or sulfide) or Group 17 element (halide). For purposes of the invention, the salt composition should not dissolve into the thermoplastic polymer (component (i)), but rather, the salt composition should be dry-mixed to form solid particles dispersed in the thermoplastic polymer. In some embodiments, a single cationic element is present in the salt, while in other embodiments, two or more cationic elements are present. The cationic element may be selected from, for example, alkali elements, alkaline earth elements, main group (metalloid) elements, transition metal elements, and lanthanide elements. Some examples of alkali elements include cationic forms of Li, Na, K, and Rb. Some examples of alkaline earth elements include cationic forms of Mg, Ca, Sr, and Ba. Some examples of main group elements include cationic forms of B, Al, Ga, In, Si, Ge, Sn, As, and Sb. The transition metal elements (Groups 3-12) include the first row transition metals, second row transition metals, and third row transition metals, or more particularly, cationic forms of any one or more of Sc, Ti, V, Cr, Mn, Fe, Co, Ni, Cu, Zn, Y, Zr, Nb, Mo, Tc, Ru, Hf, Ta, or W. The lanthanide elements refer to elements having atomic weights of 57-71, e.g., any one or more of La, Ce, Pr, Nd, Sm, Eu, Gd, Tb, Dy, Ho, Er, Tm, Yb, and Lu. In particular embodiments, the cationic element(s) is/are selected from the group consisting of aluminum (Al), boron (B), magnesium (Mg), calcium (Ca), strontium (Sr), and barium (Ba). Some examples of anions include hydroxide, carbonate, sulfate, thiosulfate, nitrate, phosphate, borate, cyanate, and thiocyanate, or more particularly, hydroxide, carbonate, and sulfate. Any of the cationic elements disclosed herein may be combined with any of the foregoing anions to form a salt. Some examples of salt compositions include Al(OH)₃, Si(OH)₄, B(OH)₃, Fe(OH)₃, Fe(OH)₂, FeO(OH), MgCO₃, CaCO₃, SrCO₃, BaCO₃, ZnCO₃, Li₂CO₃, Na₂CO₃, K₂CO₃, Rb₂CO₃, Cs₂CO₃, Al₂(SO₄)₃, Fe₂(SO₄)₃, La₂(C₀₃)₃, MgSO₄, CaSO₄, SrSO₄, BaSO₄, ZnSO₄, Li₂SO₄, Na₂SO₄, K₂SO₄, Rb₂SO₄, and Cs₂SO₄. In some embodiments, any one or more of the above described cations, anions, or salt compositions is/are excluded.

In another set of embodiments, the solid particles have an oxide or sulfide (or metal oxide or metal sulfide) composition. As well known, particles having an oxide or sulfide composition typically include surface hydroxy or thiol groups, which, for purposes of the present invention, aid in bonding to a surface and hence increase the adhesive strength. While the oxide or sulfide particles may include one or more non-oxide or non-sulfide groups (e.g., hydroxide, sulfate, nitrate, or carbonate), the oxide or sulfide particles preferably do not include a halide. For purposes of the invention, the oxide or sulfide composition should not dissolve into the thermoplastic polymer (component (i)), but rather, should form insoluble solid particles dispersed in the thermoplastic polymer.

The term “metal” (which is present as a cationic element to counterbalance the oxide or sulfide anions), as used herein, can refer to any element selected from alkali, alkaline earth, main group, alkali, alkaline earth, transition metal, and lanthanide elements, as described in detail above. In some embodiments, a single cationic element is present in the oxide or sulfide composition, while in other embodiments, two or more cationic elements are present in the oxide or sulfide composition. The oxide or sulfide composition may be a main group metal oxide or sulfide, alkali metal oxide or sulfide, alkaline earth metal oxide or sulfide, transition metal oxide or sulfide, or lanthanide metal oxide or sulfide composition. Some examples of main group metal oxide compositions include SiO₂ (i.e., silica, e.g., glass or ceramic), B₂O₃, Al₂O₃ (alumina), Ga₂O₃, SnO, SnO₂, PbO, PbO₂, Sb₂O₃, Sb₂O₅, and Bi₂O₃. Some examples of alkali metal oxides include Li₂O, Na₂O, K₂O, Rb₂O, and Cs₂O. Some examples of alkaline earth metal oxide compositions include BeO, MgO, CaO, SrO, and BaO. Some examples of transition metal oxide compositions include Sc₂O₃, TiO₂ (titania), Cr₂O₃, Fe₂O₃, Fe₃O₄, FeO, FeO(OH), Co₂O₃, Ni₂O₃, NiO, CuO, Cu₂O, ZnO, Y₂O₃(yttria), ZrO₂ (zirconia), NbO₂, Nb₂O₅, RuO₂, PdO, Ag₂O, CdO, HfO₂, Ta₂O₅, WO₂, and PtO₂. Some examples of lanthanide metal oxide compositions include La₂O₃, Ce₂O₃, and CeO₂. In particular embodiments, the metal oxide composition is selected from one or more of the following compositions: Al₂O₃, B₂O₃, SiO₂, Fe₂O₃, Fe₃O₄, FeO, FeO(OH), MgO, CaO, SrO, BaO, ZnO, Li₂O, Na₂O, K₂O, Rb₂O, and Cs₂O, and/or corresponding sulfide compositions of any of these (i.e., where O is replaced by S, such as in Li₂S, MgS, or CaS). In some embodiments, the particles are composed of mixed metal oxides, which correspond to oxide compositions containing more than one metal. Some of the oxide compositions above may be moderately or substantially unstable or reactive, such as Na₂O, K₂O, Rb₂O, Cs₂O, CaO, SrO, BaO, FeO, Co₂O₃, Ni₂O₃, Ag₂O, La₂O₃, or Ce₂O₃, in which case special conditions (e.g., inert atmosphere) may be needed to process them with the polymer to form the adhesive, or alternatively, such compositions may be excluded from the adhesive. Alternatively, the reactive or unstable material is permitted to decompose or react during mixing with the polymer under ambient conditions, and the product of such decomposition or reaction function as particles of component (ii), e.g., Ni₂O₃ decomposing to NiO. In some embodiments, any one or more classes or specific types of the foregoing metal oxides (or all metal oxides) and/or sulfides are excluded from the adhesive composition.

In some embodiments, the solid particles are metal oxide particles having a perovskite structure of the formula:

M′M″O₃ (1)

In Formula (1) above, M′ and M″ are different metal cations, thereby being further exemplary of mixed-metal oxide compositions. The metal cations can be independently selected from, for example, the first, second, and third row transition metals, lanthanide metals, and main group metals. More typically, M′ represents a trivalent metal and M″ represents a transition metal, and more typically, a first row transition metal. Some examples of perovskite oxides include LaCrO₃, LaMnO₃, LaFeO₃, YCrO₃, and YMnO₃. In some embodiments, one or more (or all) perovskite compositions are excluded from the adhesive composition.

In other embodiments, the solid particles are metal oxide particles having a spinel structure of the formula:

Mₓ′M″₃₋ₓO₄ (2)

In Formula (2) above, M′ and M″ are the same or different metal cations. Typically, at least one of M′ and M″ is a transition metal cation, and more typically, a first-row transition metal cation. In order to maintain charge neutrality with the four oxide atoms, the oxidation states of M′ and M″ sum to +8. Generally, two-thirds of the metal ions are in the +3 state while one-third of the metal ions are in the +2 state. The +3 metal ions generally occupy an equal number of tetrahedral and octahedral sites, whereas the +2 metal ions generally occupy half of the octahedral sites. However, Formula (2) includes other chemically-acceptable possibilities, including that the +3 metal ions or +2 metal ions occupy only octahedral or tetrahedral sites, or occupy one type of site more than another type of site. The subscript x can be any numerical (integral or non-integral) positive value, typically at least 0.01 and up to 1.5.

In particular embodiments of Formula (2), the spinel structure has the composition:

M′M″₂O₄ (2a)

In Formula (2a) above, M″ is typically a trivalent metal ion and M′ is typically a divalent metal ion. More typically, M′ and M″ independently represent transition metals, and more typically, first row transition metals. Some examples of spinel compositions include NiCr₂O₄, CuCr₂O₄, ZnCr₂O₄, CdCr₂O₄, MnCr₂O₄, NiMn₂O₄, CuMn₂O₄, ZnMn₂O₄, CdMn₂O₄, NiCo₂O₄, CuCo₂O₄, ZnCo₂O₄, CdCo₂O₄, MnCo₂O₄, NiFe₂O₄, CuFe₂O₄, ZnFe₂O₄, CdFe₂O₄, and MnFe₂O₄. M′ and M″ can also be combinations of metals, such as in (Co,Zn)Cr₂O₄, and Ni(Cr, Fe)₂O₄. In some embodiments, one or more (or all) spinel compositions are excluded from the adhesive composition.

For purposes of the invention, the salt or oxide/sulfide of component (ii) should not include multidentate (e.g., bidentate, tridentate, tetradentate, or higher dentate) ligands. Such ligands hinder the ability of the salt or oxide/sulfide particles to form favorable interactions with surfaces when the adhesive composition is used in practice.

In some embodiments, the adhesive composition contains one or more modifying components, which may be denoted as an optional component (iii). The modifying component may be included in an amount of 0.1-20 wt % (or more particularly, 0.1-10 wt %, 0.1-5 wt %, 0.1-2 wt %, or 0.1-1 wt %) by weight of components (i) and (ii). The modifying component may be one or more selected from, for example, carbon particles, basalt particles, natural particles (e.g., cellulose or lignin), ceramic particles, glass particles, and Lewis acid compounds (e.g., boron-containing compounds, such as boric acid or a borate salt), wherein Lewis acid compounds may be dissolved in the component (i) thermoplastic polymer or may be present in particle form. The modifying particles may have any of the sizes or size ranges provided above for the solid particles of component (ii). The carbon particles can be any of the carbon particles known in the art that are composed substantially of elemental carbon. Some examples of carbon particles include carbon black (“CB”), graphene, graphene oxide, graphene nanoribbons, carbon onion (“CO”), spherical fullerenes (e.g., buckminsterfullerene, i.e., C₆₀, as well as any of the smaller or larger buckyballs, such as C₂₀ or C₇₀), tubular fullerenes (e.g., single-walled, double-walled, or multi-walled carbon nanotubes), carbon nanodiamonds, and carbon nanobuds, all of which are well known in the art. In some embodiments, the carbon particles can be any of the high strength carbon fiber compositions known in the art, such as those produced by pyrolysis of polyacrylonitrile (PAN), viscose, rayon, pitch, lignin, polyolefins, as well as vapor grown carbon nanofibers, or chopped versions thereof. In some embodiments, any one or more of the foregoing modifying components are excluded. In some embodiments, the adhesive composition contains solely components (i) and (ii).

In another aspect, the present disclosure is directed to a method of producing the adhesive composition described above. In a typical process, the thermoplastic polymer is mixed with the solid salt or oxide particles (and any other modifying particles, if desired) to form a homogeneous mixture. Typically, a solvent is excluded from the mixture. The components may be mixed by any of the means well known in the art. The components may be mixed by, for example, high-speed mixing, shear mixing, compounding, extrusion, or ball mixing, all of which are well-known in the art.

In another aspect, the present disclosure is directed to a method of bonding first and second surfaces together by use of any of the above-described adhesive compositions, which includes any combination of the above exemplified thermoplastic polymers and solid particles. In the method, any of the adhesive compositions described above is placed between the first and second surfaces followed by hot pressing the surfaces to result in bonding of the first and second surfaces through the adhesive layer. In some embodiments, the adhesive composition is applied onto the first surface followed by placing the second surface onto the adhesive composition on the first surface, before hot pressing the surfaces. The surfaces being bonded may be made of the same or different materials. One or both of the surfaces being bonded may be selected from, for example, metal, glass, ceramic, paper, or wood. For purposes of the invention, the term “metal surface” may also include “metalloid surfaces,” wherein metalloids typically refer to elements in Groups 13-16 of the Periodic Table. In some embodiments, at least one of the first and second surfaces contains one or more metals, such as iron, aluminum, copper, nickel, cobalt, zinc, chromium, tin, silicon, or titanium, or an alloy of these or any other metals (e.g., brass, bronze, and various aluminum and steel alloys). The alloy may be magnetic or non-magnetic. In the case of one or both surfaces having a ceramic composition, the ceramic composition may be any of the metal oxide, carbide, nitride, or boride compositions known in the art, such as silicon oxide, silicon carbide, silicon nitride, aluminum oxide, zeolites, and clays. In some embodiments, the surface is conditioned before being bonded. The conditioning may serve to improve the adhesion. For example, the surface may first undergo an oxygenating pre-treatment, such as an oxygen plasma or chemical pre-treatment or etch, before undergoing the bonding process. In other embodiments, the surface is not conditioned before bonding. Notably, the process may be used to bond more than two surfaces together, such as three, four, five, six, or more surfaces.

The hot pressing it typically conducted at a temperature of at least or above 80° C. In different embodiments, the surfaces are hot pressed at a temperature of precisely or about, for example, 70° C., 80° C., 90° C., 100° C., 120° C., 150° C., 180° C., 200° C., 220° C., or 250° C., or a temperature within a range bounded by any two of the foregoing values, e.g., 70-250° C., 70-220° C., 70-200° C., 70-180° C., 70-150° C., 70-120° C., 70-100° C., 80-250° C., 80-220° C., 80-200° C., 80-180° C., 80-150° C., 80-120° C., 90-250° C., 90-220° C., 90-200° C., 90-180° C., 90-150° C., 90-120° C., 100-250° C., 100-220° C., 100-200° C., 100-180° C., 100-150° C., or 100-120° C. The surfaces are hot pressed at any of the above temperatures or ranges thereof for a period of about or at least, for example, 5, 10, 15, 30, 45, or 60 minutes, or a time period within a range bounded by any two of the foregoing values. The pressure applied to the surfaces during the hot pressing is typically at least gravitational pressure or a pressure of 0.1 MPa, 0.2 MPa, 0.5 MPa, 0.8 MPa, 1 MPa, 1.2 MPa, 1.5 MPa, 2 MPa, 5 MPa, 10 MPa, 20 MPa, 30 MPa, 40 MPa, or 50 MPa, or a pressure within a range bound by any two of the foregoing values (e.g., 0.1-50 MPa, 0.2-50 MPa, 0.5-50 MPa, 0.5-20 MPa, 0.5-10 MPa, 0.5-5 MPa, 1-50 MPa, 1-20 MPa, 1-10 MPa, or 1-5 MPa). The surfaces become bonded upon cooling of the surfaces to ambient temperature, approximately 18-30° C. or about 25° C., or more broadly, a temperature below the polymer melting point, such as between room temperature and up to 10° C. degrees below the polymer melting point.

The adhesive compositions described herein may exhibit an exceptionally strong adhesion, such as at least or above, for example, 5, 8, 10, 12, 15, 18, or 20 MPa or an adhesion strength within a range between any two of these values. The adhesive composition may also exhibit an exceptionally high work of debonding at ambient temperature, e.g., at least or above 500, 600, 700, 800, 900, or 1000 N/m.

In some embodiments, the bonded surfaces may, in a successive step, be thermally debonded by applying any of the above temperatures to the bonded surfaces while pulling or sliding the surfaces apart. Alternatively, the bonded surfaces may, in a successive step, be debonded by washing away all or a portion of the adhesive with an aqueous solvent, wherein the aqueous solvent may be composed of only water or a water-organic solvent mixture, such as a water-alcohol mixture. Alternatively, the adhesive may be peeled off the surface in a humid environment. The debonding process may also serve to reposition the bonded surfaces instead of completely separating them, followed by rebonding of the surfaces. After being fully or partially debonded, the surfaces may be subsequently rebonded, or the debonded adhesive composition may be removed from the surfaces and re-used for bonding other surfaces.

Examples have been set forth below for the purpose of illustration and to describe certain specific embodiments of the invention. However, the scope of this invention is not to be in any way limited by the examples set forth herein.

### EXAMPLES

### Overview

Herein is described a low-cost and scalable strategy to significantly enhance the adhesion strength of hot-melt adhesives (HMAs) to metal surfaces in composites containing poly(ethylene oxide) (PEO) and ionic (salt or oxide) particle fillers. In general, the enhanced adhesion results from the improved mechanical properties of the composites and their strengthened interfacial binding by virtue of the particle fillers.

By exploring the effects of salt chemistry on the adhesive properties of PEO-based HMAs, it is herein demonstrated that a thermoplastic PEO polymer can be readily dry-mixed with ionic salt particles and easily melted to form films. These films exhibit strong adhesive properties to metal surfaces upon heating, with a lap shear strength exceeding 10 MPa at ambient temperature for some formulations. In binding to metals, such composites outperform several commercial liquid glues and all commercial HMAs. Furthermore, besides tuning the interfacial chemistry, the inclusion of salt particles may provide other important properties, such as corrosion resistance, which provides an additional competitive advantage over other liquids adhesives and HMAs.

### Preparation of PEO-Based Adhesive Membrane

In an exemplary process for producing a PEO-based adhesive membrane, 10 g polyethylene oxide (PEO) homopolymer (molecular weight of 600,000 g/mol) with different weight percentages (3, 5, 10, 20%) of salt powders (FeCl₃, Al(OH)₃, CaCl₂), CaCO₃ H₂O, Cs₂CO₃) were mixed and hot-pressed at 80° C. for 30 minutes with constant pressure (1.38 MPa) in air to form a composite membrane. For ground samples, the dry mixture was ground with mortar and pestle followed by the hot-pressing into films. The resulting membrane thickness was about 30 micrometers. The adhesive membrane was stored in a vacuum chamber until further analysis. The composition of the samples is indicated in the nomenclature used to identify each composition. For example, PEO_10% Al(OH)₃ corresponds to PEO matrix loaded with 10 w/w % of Al(OH)₃ salt. In some cases, the original composition was modified to PEO with 10% of Al(OH)₃ along with 10% of boric acid. The foregoing composition is denoted as PEO_10% Al(OH)₃_10% Boric. These compounds were mixed as powders and hot pressed following the same protocol.

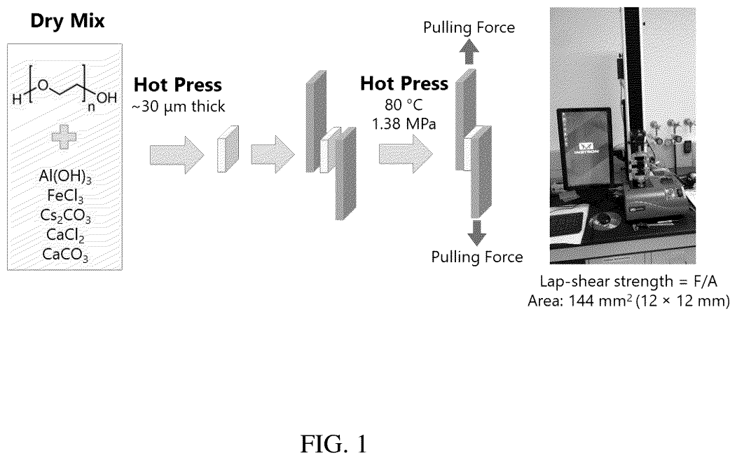

Lap shear adhesion measurements. For stainless steel, wood, and aluminum substrates, lap shear measurements were conducted following a modified version of the ASTM D1002 method (ASTM D 1002-10) in a commercial tensile frame equipped with a 5-kN load cell. Stainless steel alloy sheets were scratched with P-grade sandpaper to remove any surface oxide followed by treatment with P50 sandpaper to induce roughness. The stainless steel alloy sheets (A1008) were obtained from a commercial supplier and the same steel was used in different experiments. The adhesive membrane, with an area of 144 mm² (12 mm×12 mm) was sandwiched between the two stainless steel sheets and hot-pressed at 80° C. for 30 minutes with constant pressure (1.38 MPa). After cooling at room temperature, the lap shear tests were conducted with a constant test speed of 2 mm/min. The highest force during rupture was recorded as the breaking force (F) of each specimen, and the lap shear strength was calculated by using the following equation: Lap shear strength=Force/Adhesive Area (N/mm²). Average results of five test specimens were reported. For tensile analysis, the membrane was cut into a dog bone shape. Uniaxial tensile testing was carried out on TA instrument equipped with 1 kN sensor. An elongation rate of 1 mm/s was applied to the specimen. Average results of five test specimens were reported. The detailed schematic of the sample preparation process and lab shear testing is presented in FIG. 1.

Differential Scanning Calorimetry. The glass-transition temperature, T_{g}, and melting temperature were determined using temperature-modulated differential scanning calorimetry (TMDSC), as known in the art. Samples of about 10 mg were sealed in aluminum pans and annealed at 433 K for 20 min. Then, they were measured at 3 K/min rate with the temperature modulation amplitude and period of ±0.5 K and 60 s, respectively. T_{g} was defined as the inflection point temperature in the reversible heat flow upon heating. The melting point was defined from the peak position of the endothermic peak.

Pull-off adhesion test. A commercial automatic adhesion tester with 20 mm metal dollies was used in this test. 20 mm circles of adhesive film were placed on a cast-iron pipe, and light heating (127° C.) was applied to glue them to the pipe. Two-part epoxy glue was used to attach dollies to the surface of the buffer layer. C-clamps were used to firmly press the dolly onto the surface of the composite. This construct was left undisturbed for at least 18 hours at room temperature. Before testing, the C-clamps were removed.

Corrosion testing. Corrosion testing of the best-functioning PEO-based adhesive membranes was measured using the same sample preparation as the lap shear test, except that a thin Ag/AgCl wire was placed into the melt to serve as a reference electrode. Corrosion measurements were based on the ASTM-G59 linearized polarization resistance protocol, where after a 30 min rest, the potential was swept from −100 to +100 mV vs open circuit potential (OCP) using a 10 mV/min scan rate. This measurement was done as a function of temperature with 2 hours of settling time before each scan.

Scanning Electron Microscope (SEM). SEM with an acceleration voltage of 10 kV was used to evaluate the surface morphology and size of the salt powders. The non-conductive samples of microcapsules were sputter-coated with carbon for 10 s before testing, using a high vacuum turbo evaporator.

Dynamic Mechanical Analysis (DMA). DMA was measured using a commercial system that included a tension clamp. After hot-pressing the samples, the films were cut into rectangular shapes. Each sample was tested in a temperature range from −100° C. to 100° C. at a rate of 3° C. min⁻¹ with a frequency of 1 Hz and 15 μm amplitude.

### Results and Discussion

PEO is a nonionic but highly ion-coordinating polymer composed of oxyethylene repeating units of the form (CH₂CH₂O—)ₙ. It is readily melted without degradation between 65 and 75° C. depending on its molecular weight and the concentration of dissolved salt (B. K. Money et al., Macromolecules 2013, 46, 6949-6954). Dry PEO powder (M_{w}=600,000 g mol⁻¹) was used to prepare the HMAs. The bulk properties of the PEO-HMAs were tuned by utilizing salts with different metal ion valences, ion sizes, and metal affinities. The salts that were studied included the following: FeCl₃, Al(OH)₃, CaCl₂), CaCO₃, and Cs₂CO₃. These salts were used to leverage the varying metal ion-polymer coordination strengths to tune the interactions within the composite and between the composite and metal surfaces through hydrogen bonds or electrostatic interactions. The PEO powder was dry-mixed with the salts (3 to 20 w/w %) followed by hot-processing of the dry salt-polymer mixture into films.

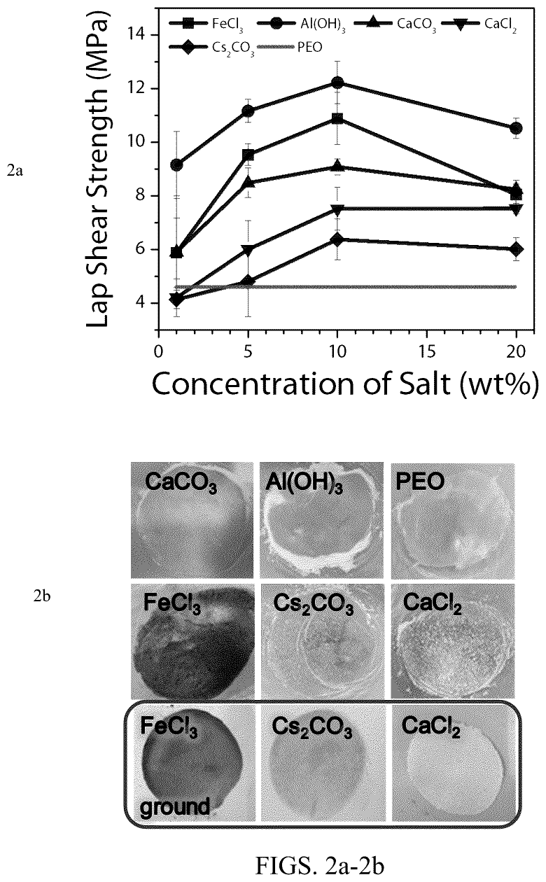

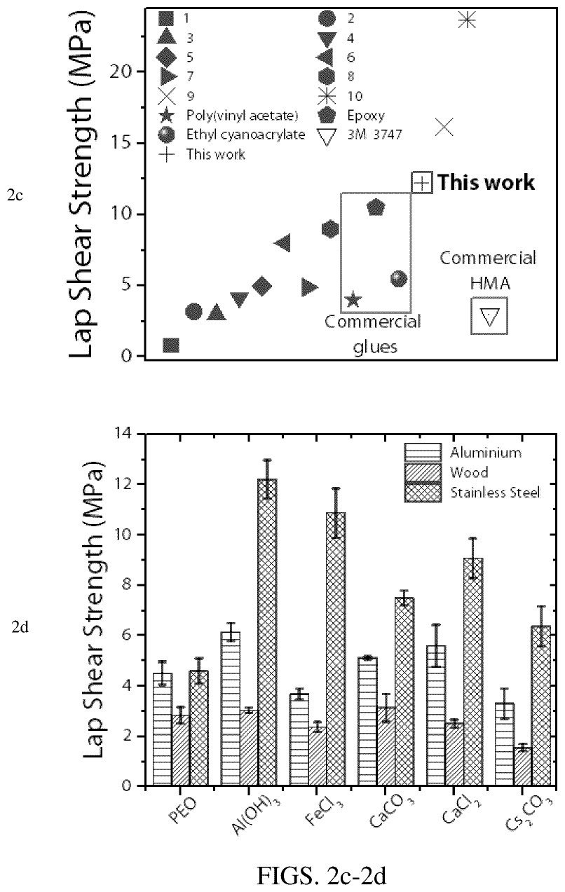

To evaluate the adhesion of the films to metal substrates, films were hot-pressed between two stainless steel tabs. Their adhesive properties were characterized using a modified version of the ASTM D1002 method, which produced lap shear strength results for different HMA composites. The steps of sample preparation starting from powders and the method used to test adhesion are schematically shown in FIG. 1. The lap shear strength plotted against salt concentrations for the composites is presented in FIG. 2a. The quality of the hot-processed films made of a dry salt-polymer mixture is presented in FIG. 2b. Regardless of the salt chemistry, the composites significantly outperformed pure PEO, with the general trend being that lap shear strength increased with added salt concentration and peaked at 10 wt %. Additional salt had either no effect or was deleterious. The observed trend in lap shear strength with salt concentration may indicate the contribution of several interrelated factors, including changes in surface chemistry, bulk mechanical properties, and salt dispersion. These factors, along with particle characteristics (such as size and chemistry), are discussed in detail below.

Among all samples, PEO_10% Al(OH)₃ showed the highest adhesion (12±1 MPa), while PEO_10% FeCl₃ was the second highest (11±1 MPa). FIG. 2c compares the performance of 10% Al(OH)₃ with biobased, supramolecular, mussel-inspired, and bio-inspired synthetic adhesives, as well as commercial glues including commercial HMA. As seen from FIG. 2c, the lap shear strength of PEO_10% Al(OH)₃ was 40% higher than polyurethane commercial glue (8.5 MPa), 20% higher than the epoxy-based commercial glue (10 MPa), and 400% higher than 3M™ 3747 (3 MPa) HMA.

Given the maximum lap shear strength on stainless steel of all the composites was at 10% salt loading (FIG. 2a), a 10 wt % salt loading was herein taken as the standard formulation to compare adhesion to other materials, such as wood and aluminum. FIG. 2d shows lap shear strength of PEO+10 w/w % of salts measured on different substrates (aluminum, wood, and stainless steel). Compared to performance on steel, the presently described composite HMAs were less effective on the wood and aluminum substrates. For aluminum substrates, 10% Al(OH)₃ and 10% CaCO₃ were the best performing formulations with adhesive values of 6.2 and 5.2 MPa, respectively. While they exhibited reduced performance compared with J-B Weld™ epoxy liquid glues (˜7.5 MPa), they again outperformed the commercial 3M™ 3747 HMA (3 MPa). On wood, 10% Al(OH)₃ and 10% CaCO₃ outperformed other studied composites, both achieving adhesion of approximately 3 MPa. These lap shear strength values were greater than commercial glues Titebond™ and Weldbond™ (around 2.6 MPa) and the commercial 3M™ 3792 HMA (1.7 MPa) but comparable to the performance of pure PEO (˜2.8 MPa).

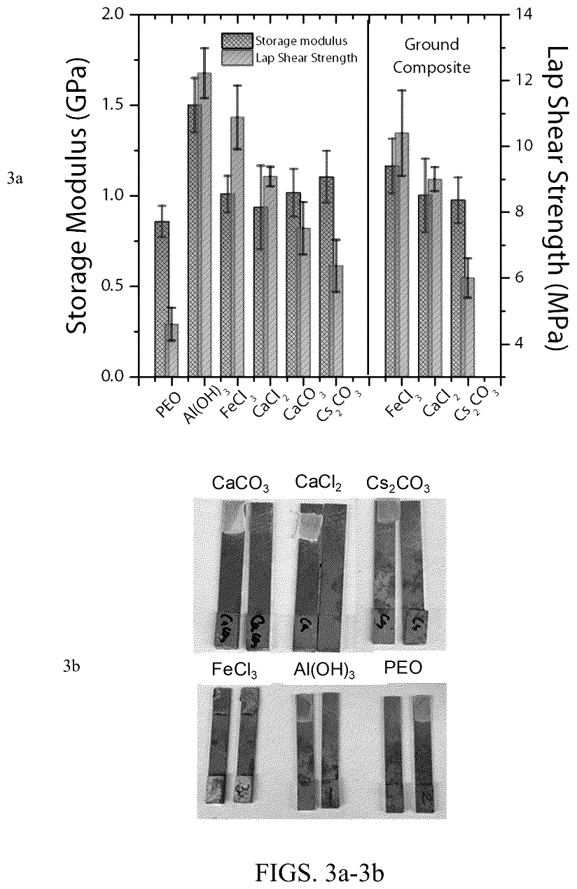

To gain an understanding of the mechanisms driving the adhesion of the composites to metal and other surfaces, factors were evaluated that could change cohesive and adhesive forces. DMA was used to measure the bulk mechanical properties of the composites at 21° C. on composites with maximal adhesion, which contained 10 wt % of different salts. Their storage moduli and corresponding lap shear strengths are presented in FIG. 3a. The addition of salt particles improved the storage modulus compared to pure PEO in all cases, which also correlated with the enhancement in adhesion. A significant improvement in both mechanical properties and adhesion was achieved in the composite with added Al(OH)₃, while the rest of the salt composites demonstrated a strong but comparable increase in storage moduli (ranging between 1000-1200 MPa) compared to the PEO sample (860 MPa), with adhesion showing a much broader variability. Based on microscopy images of composites, films containing 10% salts showed a relatively uniform distribution of salt particles in the composite with a strong variability in the particle size. Of all the salts examined, the Al(OH)₃ particles are the smallest, approximately 9 μm, potentially exerting a more significant influence on enhancing mechanical properties owing to their higher surface-to-volume ratio. Effects of particle sizes on mechanical properties and adhesion were studied in composites with relatively large sizes (hundreds of microns) including PEO_10% FeCl₃, PEO_10% Cs₂CO₃, and PEO_10% CaCl₂.

To achieve a size reduction, the salt powder was crushed using a mortar and pestle before mixing the samples. Images of the composite films containing ground salts are shown in the third row of FIG. 2b, which illustrates the reduction in particle size. Analysis of SEM images of the salt powder suggested that, after grinding, the size of the particles in these composites was reduced by at least a factor of 5, resulting in sizes of approximately 30 μm, 60 μm, and 80 μm in PEO_10% FeCl₃, PEO_10% Cs₂CO₃, and PEO_10% CaCl₂), respectively. The adhesion and storage moduli of the composites before and after grinding are provided in FIG. 3a. While the storage modulus was either slightly improved or unchanged after grinding, it did not affect the adhesion of the composites to the metal surfaces. A clear benefit of grinding was observed in improving the toughness of the materials through improvement in elongation. The best elongation and material toughness in unground samples were achieved in composites with PEO, PEO_10% Al(OH)₃, and PEO_10% CaCO₃. Grinding improvements in material elongation reached an average factor of 2, with a particularly strong improvement by a factor of ˜4 achieved for PEO_10% FeCl₃.

To gain an insight into the interactions between the particles and polymer in the bulk, changes in T_{g}s were evaluated. For all composites, the increase in T_{g} relative to the PEO sample was observed. Except for PEO_10% FeCl₃, the increase in T_{g} did not exceed 2.5° C., indicating that the salt particles likely acted as hard fillers interacting with the PEO matrix through the filler surface. In PEO_10% FeCl₃, the increase in T_{g} exceeded 20° C., suggesting a stronger ion coordination by PEO. The increased T_{g} in composites indicated the presence of attractive interactions between the PEO and the filler, likely contributing to the observed enhancement in the mechanical properties of composites. Furthermore, while notable improvement in storage moduli in PEO_10% FeCl₃ could be easily linked to a significant increase in T_{g}, the same cannot be said for PEO_10% Al(OH)₃. Its average increase in T_{g} suggested that the improvement in mechanical properties likely benefited from other factors, among them the hardness of the particles and their smaller size.

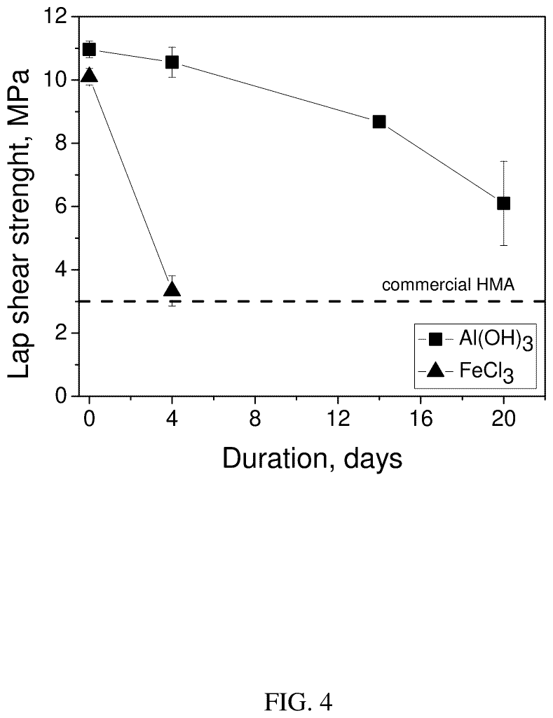

In most of the studied composites, the magnitude of the increase in the storage moduli of the composites compared to the reference PEO sample did not scale with the observed enhancement in adhesion strength. Specifically, the storage modulus in PEO_10% Al(OH)₃ increased by a factor of 1.7 vs. reference PEO, while its adhesion strength improved by 2.7. For PEO_10% FeCl₃ composite, the mechanical modulus increased by 1.2 and adhesion by 2.4. Furthermore, visual inspections of the samples after the lap shear tests, as shown by the photographs in FIG. 3b, demonstrated adhesive failure in all samples including pure PEO. This underscored that the variability in adhesion strength of the composites was influenced to a greater extent by the interfacial adhesion rather than the bulk mechanical properties. The bulk mechanical properties of the composite and the water solubility of the composites played an important role in defining the stability of the adhesive bonds. The change in adhesion strength over time was tested for PEO_10% FeCl₃ and PEO_10% Al(OH)₃. The results are presented in FIG. 4. The adhesion bond deteriorated very quickly for PEO_10% FeCl₃, which is likely due to the extreme water solubility of both compounds in water which changes both the bulk mechanical property and influences the surface adhesion. In contrast, the adhesion strength of PEO_10% Al(OH)₃ changes much more slowly over time as the salt part is not soluble in water. At the 20-day mark, the adhesion is maintained at 6 MPa, which is significantly higher than the performance of commercial HMA (highlighted with the dotted line in FIG. 4). The shelf life may be extended by varying the concentration of water-insoluble components and applying a water-repelling coating to the areas of adhesives exposed to air. On the other hand, the water sensitivity of these adhesives offers a positive side: they can be easily removed and recycled, making them environmentally friendly.

The interfacial adhesion is a complex interplay between the intermolecular interaction chemistry, wettability, and surface roughness at the composite/substrate interface. Moreover, adhesion experiments showed that composites with trivalent cations outperformed those with di- and monovalent cations, which indicates that the valency of the cation influenced the number of anions available to bind with the metal surface.

The binding or coordination affinity of the anions was hypothesized to also influence the adhesive force. The observed adhesion behavior indicates that the affinity to the metal surface decreased on the order OH⁻>Cl⁻>CO₃²⁻ (FIG. 2b). OH⁻ can promote binding through hydrogen bond formation, while Cl⁻ ions can react with metals and facilitate pitting that increases the amount of metal surface for the PEO-salt matrix to bind to. In contrast, ions like carbonate (CO₃²⁻) were less reactive with the metal surface and formed only weak hydrogen bonds. On the other hand, hydroxide-containing and carbonate-containing salts performed well on the metal oxide surfaces and wood, where the formation of hydrogen bonds was desired (FIG. 2d).

### Electrochemical Evaluation of Metal Rusting in the Presence of HMAs

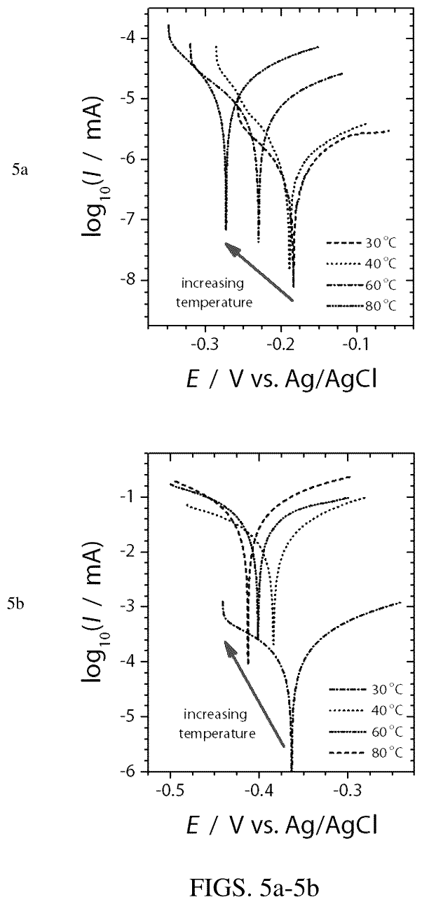

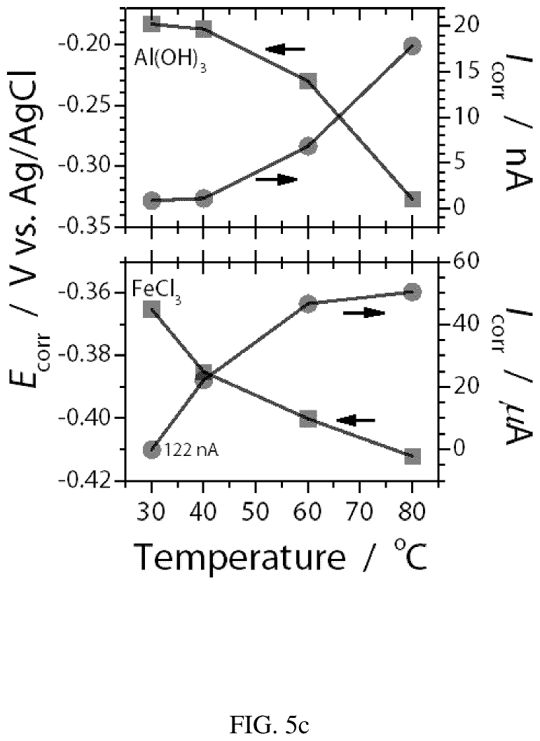

When it comes to metal surfaces, merely possessing adhesive qualities is not sufficient; stability against corrosion is also a vital aspect that should be considered as part of its adhesive properties. Linear potential sweep was used to obtain IR-corrected Tafel plots (FIGS. 5a and 5b) to evaluate the anti-corrosion performance of composite coatings containing PEO_10% Al(OH)₃ as a function of temperature and to compare it with PEO_10% FeCl₃. From the plots in FIGS. 5a and 5b, it can be observed that the E_{corr} becomes more negative with temperature and the I_{corr} increases with increasing temperature in both coatings. The Tafel profiles were fitted to the standard Butler-Volmer equation (Equation 1) to obtain corrosion current (I_{cor}) and potential (E_{corr}),

$$I = \text{} \vert {I}_{a} + {I}_{c} \vert = {I}_{c o r r} \vert exp [ \frac{α n F}{R T} ( E - {E}_{c o r r} ) ] - exp [ - \frac{( 1 - α ) n F}{R T} ( E - {E}_{c o r r} ) ] \vert \qquad ( 1 )$$

wherein I is the measured cell current; I_{corr}, the corrosion exchange current; E, the electrode potential; E⁰, the corrosion equilibrium potential; and α, the charge transfer coefficient. The resulting fits are presented in FIG. 5c. The two samples showed different values and relationships with temperature. Specifically, the FeCl₃-coated corrosion current was in the microampere range, whereas that for Al(OH)₃ was in the nanoampere range, corresponding with an order of magnitude reduction in corrosion rate. Table 1 (below) summarizes the Tafel and kinetic results.

TABLE 1
Representative fitting Tafel parameters.

| | T | E_{corr} | I_{corr} | b_{c} | bₐ | ΔS* | ΔH* |
|---|---|---|---|---|---|---|---|
| | ° C. | mV | μA | mV dec⁻¹ | | J mol⁻¹ K⁻¹ | kJ mol⁻¹ |
| Al(OH)₃ | 30 | 183 | 0.93 × 10⁻³ | 77.2 | 117 | 102 | 50.3 |
| | 80 | 327 | 1.79 × 10⁻³ | 78.6 | 169 | | |
| FeCl₃ | 30 | 365 | 50.6 | 101 | 122 | 87.8 | 19.5 |
| | 80 | 412 | 0.12 | 119 | 155 | | |

The cathodic Tafel parameter values, b_{c}, for Al(OH)₃ were between those corresponding to a 1 and 2 electron transfer process, while for FeCl₃ more closely aligned with a single electron transferring in the rate-determining step (T. Shinagawa et al., Scientific Reports 2015, S, 13801). The anodic Tafel parameters, bₐ, were always greater than b_{c}, which indicates that either the charge transfer coefficient (α) was unequal between the anodic and cathodic step, or the reaction mechanism was fundamentally different, or both. It is not uncommon for the anodic process to be transport limiting (>120 mV dec⁻¹) given the metal oxide passivation layer. Assuming mass action (Arrhenius) type behavior, the entropic and enthalpic activation parameters that correspond to the energy barrier (transition state) of corrosion were determined using the Eyring equation. Here, the Arrhenius expression was rearranged for corrosion current (Eq 2) to the linearized transition state form (Eq 3).

$${I}_{corr} = A * exp ( - \frac{{E}_{a}}{RT} ) = A * exp ( - \frac{Δ H * - T Δ S *}{RT} ) \qquad ( 2 )$$

$$Ln ( \frac{{I}_{corr}}{T} ) = - \frac{Δ H *}{R} ( \frac{1}{T} ) + [ Ln ( A \text{*)} + \frac{Δ S *}{R} ] \qquad ( 3 )$$

Both the activation enthalpy and entropy changes of the samples were positive. The ΔH* values showed that the enthalpic corrosion barrier for FeCl₃ was near half that of Al(OH)₃, and both revealed typical endothermic metal dissolution. The positive ΔS* values indicate that the corrosion reaction increased the disorder of the system (there was a dissociation process), with Al(OH)₃ providing some additional barrier, presumably due to the extended metal (hydr)oxide network at the surface. Lastly, it was observed that the Eₐ values of both the Al(OH)₃ and FeCl₃ coated samples (53.0 and 22.3 kJ mol⁻¹, respectively) were near the corresponding H*values, which show a difference on the order of RT (2.7 kJ mol⁻¹). Such a small difference between E. and H* suggests that the ground state is similar in energy to the transition state, which indicates a unimolecular dissolution process (e.g., K. J. Laidler et al., The Journal of Physical Chemistry 1983, 87, 2657-2664). These results indicate that the Al(OH)₃-coating may provide an additional anti-corrosion benefit beyond adhesion. PEO_10% FeCl₃, however, would not be as favored due to the high corrosion rate, which may lead to a weakening of the adhesion over time, though long term corrosion-adhesion correlation studies would be needed to confirm this.

### Testing Ability of HMAs to Bind to Other Metal Surfaces

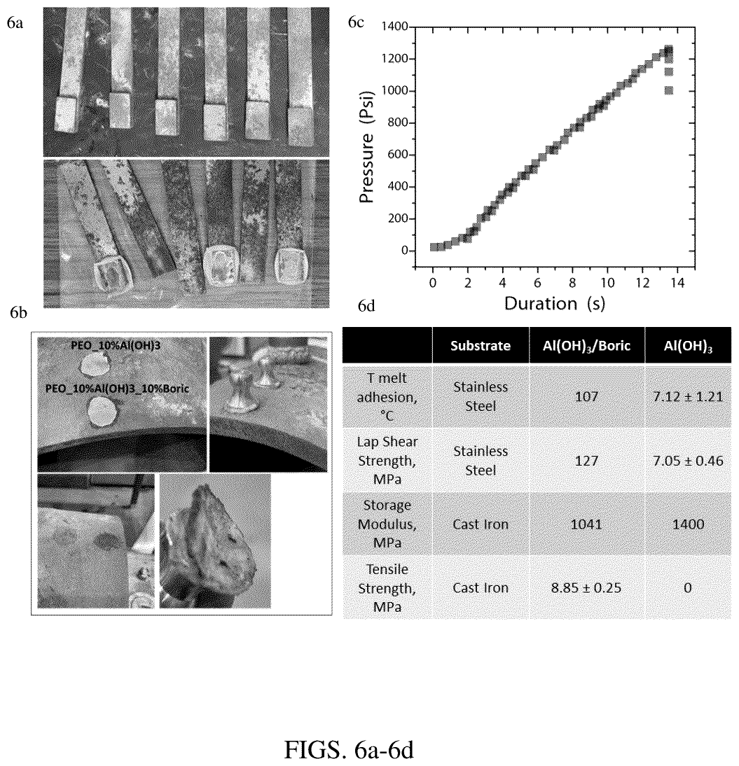

Given its ion coordination ability and oxygen-rich structure, it may herein be hypothesized that the PEO matrix chemistry can be tailored to meet the adhesion requirements not only for stainless steel, as indicated by the data above, but also for binding various metals, including rusted ones. Rusted cast-iron and stainless steel pipes are part of historic infrastructure, and replacing them can be very costly. Current efforts for pipe repair include rejuvenating them through the development of various protecting coatings. However, rust significantly complicates the adhesion process, necessitating additional rust removal procedures to ensure proper adhesion. Initial assessments indicated that the PEO_10% Al(OH)₃ composite did not adhere well to rusted surfaces. However, by incorporating 10 wt % of boric acid, which serves as an anti-rusting agent, a significant improvement was observed in adhesion for rusted stainless steel and cast-iron surfaces. The sample preparation procedure and the lap shear testing results on the stainless steel flat electrodes and cast-iron pipe are shown in FIGS. 6a and 6b, respectively. Lap shear testing of samples on a rusted stainless steel surface showed robust adhesion between the two metal surfaces, with an adhesion strength of 7 MPa. The adhesion to the pipe, measured by pull-off tests (FIG. 6c), resulted in an average adhesive failure value of 8.9 MPa. Post-test visual inspections indicated adhesive failure and the removal of the rusted coating from the surface for both surfaces, with corresponding data tabulated in FIG. 6d. Based on these experiments, it was herein found that the application of PEO-based salt formulations could be extended beyond the adhesion to stainless steel surfaces in ways that substantially broaden the practical application of these materials.

### CONCLUSION

The present results demonstrate that HMAs based on polyethylene oxide and metal salts are promising candidates for practical applications. These adhesives performed as well as existing HMAs for binding various surfaces and significantly outperformed commercial HMAs when it came to binding metal surfaces. Moreover, these materials are readily amenable to scaling up and industrial processing, making them a viable option for commercialization. The enhanced HMA composite adhesion is likely due to the affinity of the anion to both the steel surface and solubilized cations. The ability of PEO to coordinate ions played an important role in improving the storage moduli of the bulk (increasing to around 1041 MPa) by creating a percolated network between the polymer and the salt particles. Both surface adhesion and mechanical properties were enhanced in the composite with added Al(OH)₃ and FeCl₃, but only the former provided the additional benefit of resisting corrosion. Moreover, incorporating boric acid enhanced the composite's ability to bind to rusted surfaces made of cast iron and stainless steel.

While there have been shown and described what are at present considered the preferred embodiments of the invention, those skilled in the art may make various changes and modifications which remain within the scope of the invention defined by the appended claims.

What is claimed is:

1. An adhesive composition comprising:
(i) a thermoplastic polymer; and
(ii) solid particles having an oxide or salt composition embedded within the thermoplastic polymer, wherein the salt composition contains a cationic element associated with one or more anions that are not halide atoms.

2. The composition of claim 1, wherein the anions are selected from the group consisting of hydroxide, carbonate, sulfate, thiosulfate, nitrate, phosphate, borate, cyanate, and thiocyanate.

3. The composition of claim 1, wherein the anions are selected from the group consisting of hydroxide, carbonate, and sulfate.

4. The composition of claim 1, wherein the cationic element is selected from the group consisting of alkali elements, alkaline earth elements, transition metal elements, main group (metalloid) elements, and lanthanide elements.

5. The composition of claim 1, wherein the cationic element is selected from the group consisting of aluminum (Al), boron (B), magnesium (Mg), calcium (Ca), strontium (Sr), and barium (Ba).

6. The composition of claim 1, wherein the salt composition is selected from the group consisting of Al(OH)₃, Si(OH)₄, B(OH)₃, Fe(OH)₃, Fe(OH)₂, FeO(OH), MgCO₃, CaCO₃, SrCO₃, BaCO₃, ZnCO₃, Li₂CO₃, Na₂CO₃, K₂CO₃, Rb₂CO₃, Cs₂CO₃, Al₂(SO₄)₃, Fe₂(SO₄)₃, La₂(C₀₃)₃, MgSO₄, CaSO₄, SrSO₄, BaSO₄, ZnSO₄, Li₂SO₄, Na₂SO₄, K₂SO₄, Rb₂SO₄, and CS₂SO₄.

7. The composition of claim 1, wherein the oxide composition is selected from the group consisting of Al₂O₃, B₂O₃, SiO₂, Fe₂O₃, Fe₃O₄, FeO, FeO(OH), MgO, CaO, SrO, BaO, ZnO, Li₂O, Na₂O, K₂O, Rb₂O, and Cs₂O.

8. The composition of claim 1, wherein the thermoplastic polymer is selected from the group consisting of polyalkylene oxides (PAOs), poly(meth)acrylates, polyurethanes, polyesters, and thermoplastic epoxy resins.

9. The composition of claim 1, wherein the thermoplastic polymer is a polyalkylene oxide.

10. The composition of claim 9, wherein the polyalkylene oxide is a polymer or copolymer comprising the formula HO—(CH₂CHR—O)ₙH, wherein n is at least or greater than 100.

11. The composition of claim 9, wherein the polyalkylene oxide is a polyethylene oxide.

12. The composition of claim 1, wherein the thermoplastic polymer has a molecular weight of at least 100,000 Da.

13. The composition of claim 1, wherein the solid particles are present in the composition in an amount of 0.1-50 wt % by weight of components (i) and (ii).

14. The composition of claim 1, wherein the solid particles are present in the composition in an amount of 0.1-20 wt % by weight of components (i) and (ii).

15. The composition of claim 1, wherein the solid particles are present in the composition in an amount of 1-20 wt % by weight of components (i) and (ii).

16. The composition of claim 1, wherein the solid particles have a size within a range of 1 nm to 500 microns.

17. The composition of claim 1, wherein the solid particles have a size within a range of 1 nm to 5 microns.

18. A method of bonding first and second surfaces together, the method comprising placing an adhesive composition between the first and second surfaces and hot pressing the surfaces, wherein the adhesive composition comprises:
(i) a thermoplastic polymer; and
(ii) solid particles having an oxide or salt composition embedded within the thermoplastic polymer, wherein the salt composition contains a cationic element associated with one or more anions that are not halide atoms.

19. The method of claim 18, wherein at least one of the first and second surfaces is a metal surface.

20. The method of claim 18, wherein, in a successive step, the first and second surfaces are thermally debonded.

21. The method of claim 18, wherein, in a successive step, the first and second surfaces are debonded by washing away the adhesive with an aqueous solvent.

22. The method of claim 18, wherein the thermoplastic polymer is a polyalkylene oxide.

23. The method of claim 22, wherein the polyalkylene oxide is a polymer or copolymer comprising the formula (CH₂CHR—O)ₙH, wherein n is at least or greater than 100.

24. The method of claim 22, wherein the polyalkylene oxide is a polyethylene oxide.
